(19) United States
(12) Patent Application Publication
(10) Pub. No.: US 2016/0043658 A1
(43) Pub. Date: Feb. 11, 2016

(54) ISOLATED TRANSFORMER-LESS CAPACITIVE POWER SUPPLY

(71) Applicants: Arturo Hernadez Lopez, Apodaca (MX); Markus Ziegler, Munich (DE); Luis Manual Leon Lara, Apodaca (MX)

(72) Inventors: Arturo Hernadez Lopez, Apodaca (MX); Markus Ziegler, Munich (DE); Luis Manual Leon Lara, Apodaca (MX)

(73) Assignee: OSRAM SYLVANIA INC., Danvers, MA (US)

(21) Appl. No.: 14/813,146

(22) Filed: Jul. 30, 2015

Related U.S. Application Data
(60) Provisional application No. 62/035,376, filed on Aug. 8, 2014.

(51) Int. Cl. H02M 7/217

(52) U.S. Cl. CPC H02M 7/217

(57) ABSTRACT

An isolated transformer-less capacitive power supply, and methods for using the same to generate power, are disclosed. The power supply includes first and second input terminals to receive an alternating current (AC) voltage. The power supply also includes first rectifier circuitry coupled to the first and second input terminals. The first rectifier circuitry is configured to generate a first direct current (DC) voltage. The power supply also includes second rectifier circuitry, including a first capacitor and a second capacitor coupled to the first and second input terminals, respectively. The second rectifier circuitry is configured to receive the AC voltage via the first capacitor and the second capacitor and to generate a second DC voltage concurrently with the generation of the first DC voltage.

### CROSS-REFERENCE TO RELATED APPLICATION

The present application claims the benefit of U.S. Provisional Patent Application No. 62/035,376, filed Aug. 8, 2014 and titled “ISOLATED TRANSFORMER-LESS CAPACITIVE POWER SUPPLY”, the entire contents of which are hereby incorporated by reference.

### TECHNICAL FIELD

The present invention relates to power supplies, and more particularly, to a power supply capable of generating high and low direct current (DC) voltages without a transformer.

### BACKGROUND

Electronic devices may receive a single alternating current (AC) voltage that may be converted into a variety of DC voltages during normal operation. For example, an AC voltage may be provided to a device by, for example, an electrical grid. At least one AC to DC voltage converter may then covert the received AC voltage to at least one DC voltage. Various systems in the device may require different levels of DC voltage. For example, AC to DC or DC to DC voltage converter circuitry in the device may drive a load based on the requirements of the load, control affected by control circuitry, etc. The control circuity may require a different voltage than the load. Other systems in the device (e.g., processors, microcontrollers, user interface circuitry, etc.) may have other required operational voltages. Thus, there may be a variety of circuitry in the device to generate various DC voltages.

### SUMMARY

The conversion of AC voltage to DC voltage may be performed utilizing a variety of converter topologies. Half-wave rectifiers may rectify 50% of an AC input signal (e.g., only the positive portions or negative portions of the AC signal) while full-wave rectifiers may rectify the entire AC input signal. At least one issue with half-wave rectifiers is, since only half of the AC signal is being rectified, that asymmetric current consumption may occur. Asymmetric current consumption may be accommodated with higher capacitance and current drain to help equalize converter performance, which may also reduce the efficiency of a converter using the rectifier. Some converter topologies may also employ a transformer. While transformers may offer some advantages, the use of a transformer is problematic at least in that the transformer may amplify the effect of asymmetric current consumption in that a DC saturation offset may be generated in the converter along with more reactive power and heat. Negative impacts from these behaviors may include increased power loss that results in an overall reduction in converter efficiency.

Embodiments consistent with the present disclosure may provide low voltage power supplies comprising, for example, an isolated transformer that may be referenced to a grounded full wave rectifier to provide an efficient, low cost, reduced size power supply that may be used to power control circuitry. The various embodiments may provide an isolated efficient full wave capacitive low power supply that may be referenced to any grounded full wave rectifier, among other types of rectifiers.

Existing power supply solutions may employ a passive half wave low power supply that may suffer from various drawbacks including the need of having a higher passive element to provide enough power and unequal current consumption, which led the isolation transformer to present an undesirable DC component. Embodiments consistent with the present disclosure may overcome the drawbacks by providing symmetrical current consumption that may reduce passive component requirements (e.g., especially at low output voltages), improved overall efficiency, and as stated above, may be referenced to any full wave ground rectifier, among other types of rectifiers. The embodiments may be employed at a secondary isolated power full wave rectifier, among other circuits, and may provide power to control circuits, particularly for outdoor drivers for solid state light sources requiring 100 W or more of power (e.g., 180 W). Some embodiments may be used in drivers for solid state light sources having 0-10V dimming.

Thus, the present disclosure is directed to an isolated transformer-less capacitive power supply. Power supply circuitry may comprise at least first rectifier circuitry and second rectifier circuitry. The first rectifier circuitry may be configured to generate a first DC voltage based on AC input voltage. The second rectifier circuitry may receive the AC voltage and may generate a second DC voltage concurrently with the generation of the first DC voltage. The second rectifier circuitry may receive the AC input voltage via first and second capacitors that may each be coupled to a full wave rectifier. A third capacitor may be coupled in parallel with at least the full-wave rectifier, and may form capacitive voltage dividers with each of the first and second capacitors. A switch in parallel with the third capacitor may be controlled to cause the third capacitor to be either charged or discharged to generate the second DC voltage.

In an embodiment, there is provided a power supply system. The power supply system includes: first and second input terminals to receive an alternating current (AC) voltage; first rectifier circuitry coupled to the first and second input terminals, the first rectifier circuitry configured to generate a first direct current (DC) voltage; and second rectifier circuitry including a first capacitor and a second capacitor coupled to the first and second input terminals, respectively, the second rectifier circuitry configured to receive the AC voltage via the first capacitor and the second capacitor and to generate a second DC voltage concurrently with the generation of the first DC voltage.

In a related embodiment, the power supply system may further include isolation circuitry configured to receive the AC voltage from an external voltage source and to output the AC voltage to the first and second input terminals. In a further related embodiment, the isolation circuitry may include a transformer. In a further related embodiment, the first rectifier circuitry may include the transformer and may be configured as an inverter half bridge LCC converter.

In another related embodiment, the second rectifier circuitry may include a diode full-wave rectifier, which may include: a first diode having a cathode coupled to a power rail in the second rectifier circuitry; a second diode having a cathode coupled to an anode of the first diode at a first node and an anode coupled to ground, wherein the first capacitor may be coupled to the first node; a third diode having a cathode coupled to the power rail; and a fourth diode having a cathode coupled to an anode of the third diode at a second node and an anode coupled to ground, wherein the second capacitor may be coupled to the second node.

In a further related embodiment, the second rectifier circuitry may include a third capacitor coupled between the power rail and ground.

In a further related embodiment, the first capacitor and the third capacitor may form a first capacitor voltage divider and the second capacitor and the third capacitor may form a second capacitor voltage divider.

In another further related embodiment, the second rectifier circuitry may include: a switch coupled between the power rail and ground in parallel with the third capacitor; and control circuitry coupled to the switch. In a further related embodiment, the second rectifier circuitry may include a fifth diode coupled between the third capacitor and the switch. In another further related embodiment, the control circuitry may be configured to cause the third capacitor to charge or discharge to generate the second DC voltage at the power rail. In a further related embodiment, the control circuitry may include a hysteresis controller with analog comparators.

In another embodiment, there is provided a rectifier circuit. The rectifier circuit includes: a first capacitor and a second capacitor to receive an alternating current (AC) voltage input to the rectifier circuit; a diode full-wave rectifier coupled between a power rail and ground in the rectifier circuit and configured to receive the AC voltage via the first and second capacitors; a third capacitor coupled between the power rail and ground; a switch coupled in parallel to the third capacitor; and control circuitry coupled to the switch and configured to cause the third capacitor to charge or discharge to generate a direct current (DC) voltage at the power rail.

In a related embodiment, the first capacitor and the third capacitor may form a first capacitor voltage divider and the second capacitor and the third capacitor may form a second capacitor voltage divider. In another related embodiment, the control circuitry may include a hysteresis controller with analog comparators.

In another embodiment, there is provided a method to rectify an alternating current (AC) voltage into a direct current (DC) voltage. The method includes: receiving an AC voltage into first rectifier circuitry; generating a first DC voltage using the first rectifier circuitry; receiving the AC voltage in second rectifier circuitry; and generating a second DC voltage using the second rectifier circuitry concurrently with generating the first DC voltage.

In a related embodiment, the AC voltage may be received into the second rectifier circuitry via a first capacitor and a second capacitor in the second rectifier circuitry. In a further related embodiment, generating the second DC voltage may include rectifying the AC voltage with a diode full-wave rectifier in the second rectifier circuitry. In a further related embodiment, generating the second DC voltage may include reducing the voltage output by the diode full-wave rectifier using capacitive voltage dividers formed between both of the first and second capacitors and a third capacitor. In a further related embodiment, generating the second DC voltage may include controlling a switch coupled in parallel with the third capacitor to cause third capacitor to charge or discharge to generate the second DC voltage. In a further related embodiment, controlling the switch may include controlling the switch based on a hysteresis control scheme using analog comparators.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 illustrates a block diagram of a power supply system according to embodiments disclosed herein.

FIG. 2 illustrates circuit diagrams of voltage isolation circuitry, first rectifier circuitry and second rectifier circuitry according to embodiments disclosed herein.

FIG. 3 illustrates an example of the first rectifier circuitry according to embodiments disclosed herein.

FIG. 4 illustrates an example of the second rectifier circuitry according to embodiments disclosed herein.

FIG. 5 illustrates an example plot of a switch control signal and an example voltage at a tank capacitor in the second rectifier circuitry according to embodiments disclosed herein.

FIG. 6 illustrates a flowchart of operations to generate a first voltage and a second voltage according to embodiments disclosed herein.

### DETAILED DESCRIPTION

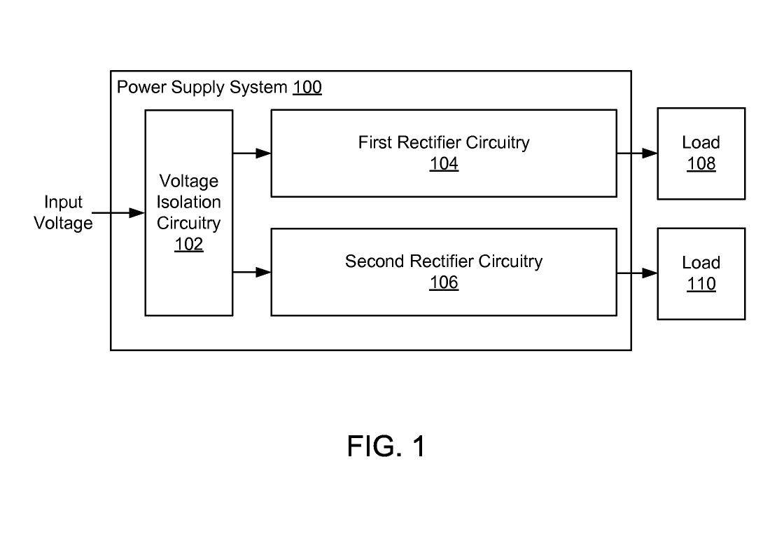

FIG. 1 illustrates a block diagram of an example power supply system 100. While various examples of circuitry including certain components will be presented herein, these examples are merely for the sake of explaining embodiments consistent with the present disclosure. Rearrangement, insertion, replacement or removal of components, component values, etc. may be permissible consistent with the overall teachings of the present disclosure. Moreover, the embodiments described herein may be discussed in terms of certain example applications, but are not limited to implementation in only the described applications.

The power supply system 100 includes, in some embodiments, voltage isolation circuitry 102, first rectifier circuitry 104, and second rectifier circuitry 106. The voltage isolation circuitry 102 is configured to receive an AC voltage from various power sources including, but not limited to, a power grid network, a generator, or at least one power cell (e.g., solar, hydrogen, biofuel, etc.). The AC voltage is received into the voltage isolation circuitry 102 via wired and/or wireless transmission. The voltage isolation circuitry 102 is configured to provide the AC voltage to the first rectifier circuitry 104 and/or the second rectifier circuitry 106.

The first rectifier circuitry 104 is configured to generate a first DC voltage based on the AC voltage, and to provide the first DC voltage to a load 108. The second rectifier circuitry 108 is configured to generate a second DC voltage based on the AC voltage, and to provide the second DC voltage to a load 110. The first rectifier circuitry 104 and second rectifier 106 are configured using a similar converter topology or with different converter topologies. In some embodiments, the first rectifier circuitry 104 is configured as a high-frequency (HF) power rectifier, while the second rectifier circuitry 106 is configured for lower power applications. In some embodiments, the power supply system 100 is incorporated in a light fixture wherein light may be generated by at least one solid state light source. Given this operational scenario, the first rectifier circuitry 104 in such embodiments may be configured to drive the load 108, where the load 108 comprises a single solid state light source, an array of solid state light sources, etc. The second rectifier circuitry 106 in such embodiments may be configured to generate lower voltages to drive the 110, where the load 110 comprises, for example, systems that control operation of the power supply system 100, operation of the light fixture, etc. In another configuration, the load 108 and the load 110 may actually be the same load that may be driven alternately by the first rectifier circuitry 104 or the second rectifier circuitry 106. For example, the first rectifier circuitry 104 may drive the light source when the light fixture is configured to emit light at or above a certain brightness level, and the second rectifier circuitry 106 may drive the light source when the light fixture is configured to emit light below the certain brightness level. This type of operation may be able to leverage beneficial characteristics of both the first rectifier circuitry 104, which may operate more efficiently at higher voltages, and the more-efficient low voltage operation of the second rectifier circuitry 106.

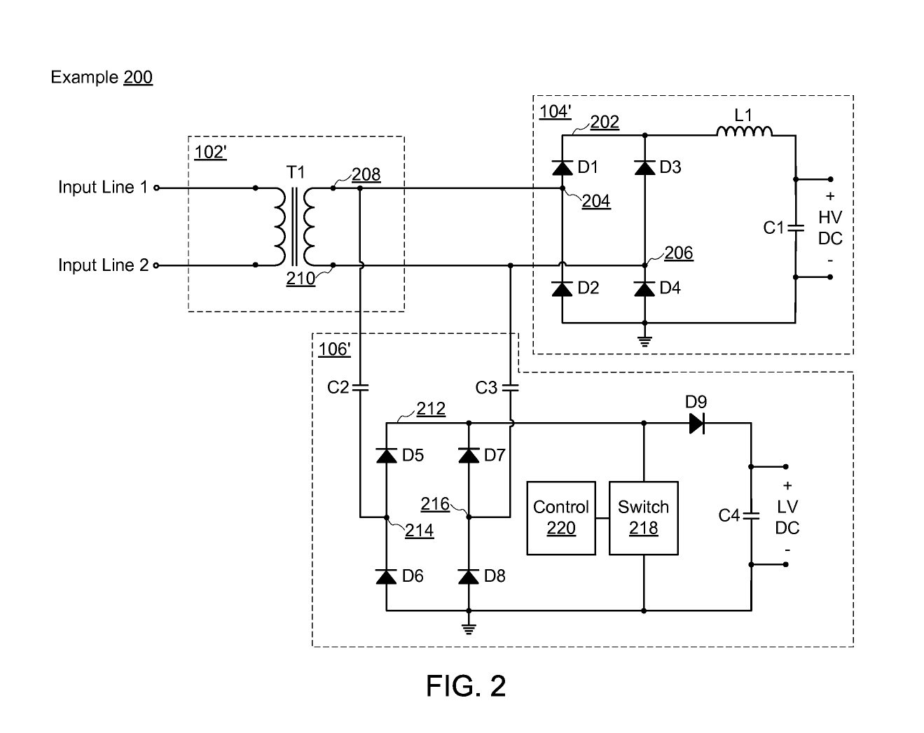

FIG. 2 illustrates circuit diagrams of example voltage isolation circuitry 102′, first rectifier circuitry 104′, and second rectifier circuitry 106′. Additional detail is provided in FIG. 2 in regard to the voltage isolation circuitry 102′, the first rectifier circuitry 104′, and the second rectifier circuitry 106′. The placement of an apostrophe after an item number in any drawing figure may indicate that an example implementation corresponding to a previously disclosed item is being shown. In some embodiments, the voltage isolation circuitry 102′ includes a transformer T1, which provides input isolation in that the source of the AC voltage is not physically connected to the first rectifier circuitry 104′ and the second rectifier circuitry 106′. Instead, the AC voltage is induced from at least one primary coil on an input side of the transformer T1 to one or more secondary coils coupled to the first rectifier circuitry 104′ and the second rectifier circuitry 106′. As the transformer T1 may comprise a variety of coil configurations, the coils to which the first rectifier circuitry 104′ and the second rectifier circuitry 106′ may be coupled may be variable based on, for example, the particular type of the transformer T1 being employed.

The first rectifier circuitry 104′ includes a diode D1, a diode D2, a diode D3, a diode D4, an inductor L1, and a capacitor C1. The diodes D1 to D4, in some embodiments, are configured in a full-wave rectifier configuration with cathodes of the diodes D1 and D3 coupled to a power rail 202, a cathode of the diode D2 coupled to an anode of the diode D1 at a node 204, while a cathode of the diode D4 is coupled to an anode of the diode D3 at a node 206. Anodes of the diodes D2 and D4 are coupled to ground. The nodes 204 and 206 are coupled to input terminals 208 and 210, respectively, to receive an AC voltage from the transformer T1. The inductor L1 and capacitor C1 are coupled in series between the cathodes of the diodes D1 and D3 and the anodes of the diodes D2 and D4. In an example of operation, an AC voltage applied to the full-wave rectifier formed by the diodes D1 to D4 is converted to a DC voltage, which is then delivered to the inductor L1 and the capacitor C1, which may together act as an LC resonant or tank circuit that generates a first DC voltage (e.g., high voltage (HV) DC). In the configuration shown in FIG. 2, the HV DC output is based on an input voltage (e.g., no control is shown to vary the output voltage).

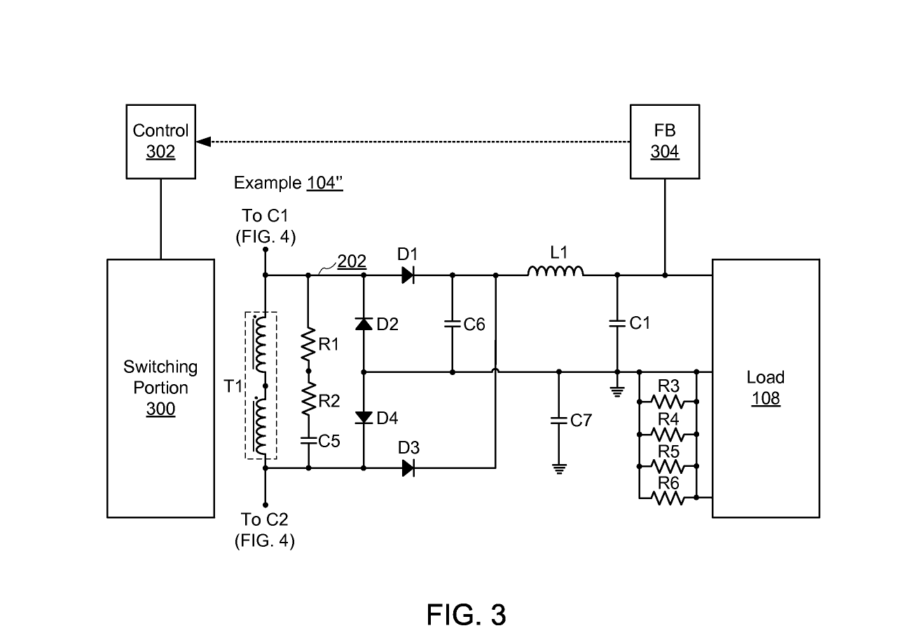

The second rectifier circuitry 106′ includes a capacitor C2, a capacitor C3, a diode D5, a diode D6, a diode D7, a diode D8, a diode D9, a switch 218, and a control 220. The diodes D5 to D8 are, in some embodiments, arranged in a full-wave rectifier configuration in a manner similar to the diodes D1 to D4. For example, in some embodiments, cathodes of the diodes D5 and D7 are coupled to a power rail 212, a cathode of the diode D6 is coupled to the anode of the diode D1 at a node 214, while a cathode of the diode D8 is coupled to an anode of the diode D7 at a node 216. Anodes of the diodes D6 and D8 are coupled to ground. The nodes 214 and 216 are coupled to the input terminals 208 and 210 via the capacitors C2 and C3, respectively, to receive an AC voltage from the transformer T1. The switch 218 is coupled between the power rail 212 and ground in parallel with the full-wave rectifier made up of the diodes D5 to D8. The capacitor C4 is coupled between the power rail 212 and ground in parallel to the switch 218. In an example of operation, the AC voltage is received through the capacitors C2 and C3 into the full-wave rectifier made up of the diodes D5 to D8. The capacitors C2 and C4 form a first capacitive voltage divider, while the capacitors C3 and C4 form a second capacitive voltage divider. The rectified DC voltage generated based on each phase of the AC voltage is reduced through the first and second capacitive voltage dividers. Current based on the reduced voltages flows through the diode D9 to charge the “tank” capacitor C4. The voltage of the capacitor C4 is controlled by causing the switch 218 to open and close. For example, when the switch 218 is closed, the voltage at the power rail 212 may drop (e.g., to the VCE saturation point of about 0.5V in embodiments where the switch 218 is a bipolar junction transistor (BJT)). When the switch 218 is opened, the capacitor C4 may charge slowly with a maximum output voltage dictated by the first and second capacitive voltage dividers. The control 220 may cause the switch 218 to open and close in a pattern to charge and discharge the capacitor C4 to generate a second DC voltage (e.g., low voltage (LV) DC). Examples of circuit configurations and switching signals will be discussed regarding FIGS. 3 to 5.

FIG. 3 illustrates an example implementation of first rectifier circuitry 104″, which is generally characterized as a secondary portion of an inverter half bridge LCC converter. A typical inverter half bridge LCC converter includes a switching portion 300 including an input side of a transformer T1, the detail of which is omitted in FIG. 3 for the sake of clarity. Further to what was described in regard to FIG. 2, the first rectifier circuitry 104″ includes a resistor R1, a resistor R2, a resistor R3, a resistor R4, a resistor R5, a resistor R6, a capacitor C5, a capacitor C6, and a capacitor C7. The additional components illustrated in FIG. 3 may generally support functionality including, but not limited to, voltage and/or current storage, support for external functionality related to the power supply system 100 shown in FIG. 1 and/or a larger system into which power supply system is incorporated (e.g., a lighting fixture), overcurrent protection, etc. As shown in FIG. 3, the resistors R1 and R2 and the capacitor C5 are coupled in series across secondary coils of the transformer T1. The capacitor C6 is coupled between a cathode of a diode D1 and an anode of a diode D2. The capacitor C7 is coupled between the anode of the diode D2 and ground. The resistors R3 to R6 are coupled in parallel between ground and a load 108. A feedback (FB) 304 is coupled to a node between an inductor L1 and the capacitor C1 to measure the output voltage of the first rectifier circuitry 104″ and to provide the measurement to a control 302. The control 302 utilizes the measured output voltage to control the switching portion 300 to set the voltage to a desired level for the load 108. For example, in embodiments where the load 108 includes one or more light sources, FB 304 provides the output voltage as feedback to the control 302 so that at least one signal driving the switching portion 300 may be set so that the light source emits light at a certain brightness level. The control 302 includes, for example, circuitry including discrete components, integrated circuits such as logic, gate arrays, etc. or a programmable solution such as a microcontroller, processor, etc.

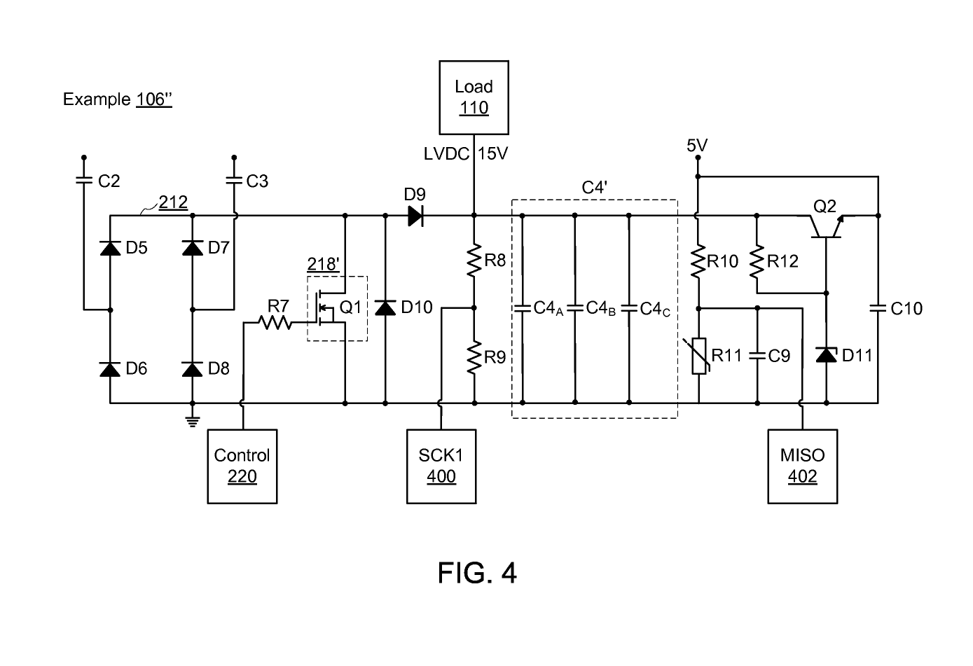

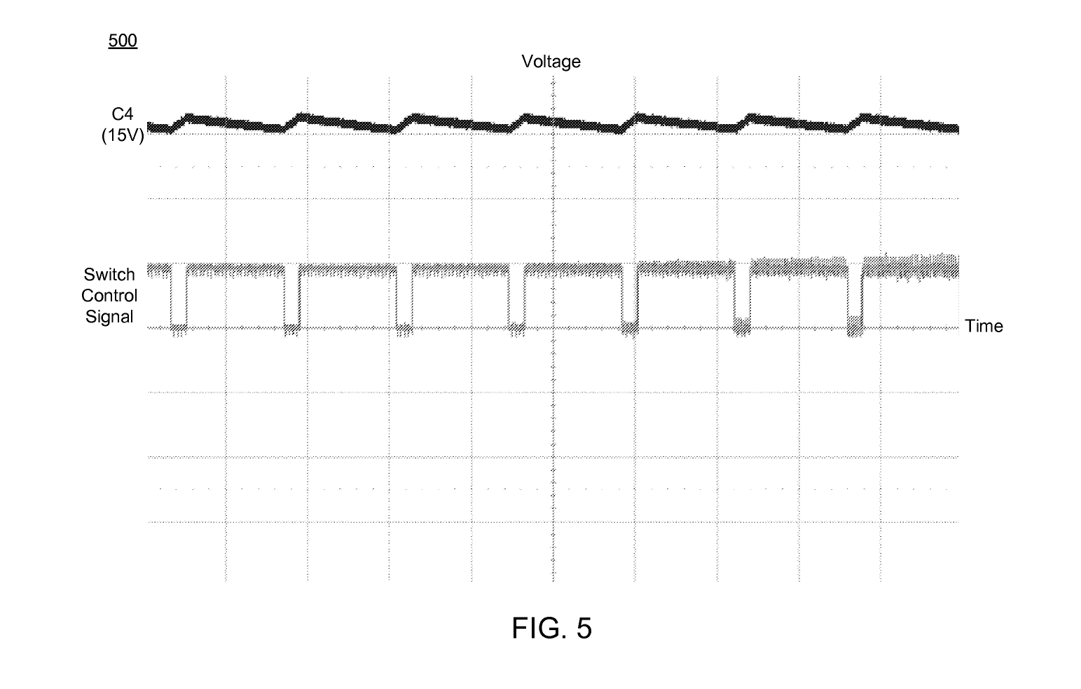

FIG. 4 illustrates an example implementation of second rectifier circuitry. Further to the second rectifier circuitry 106′ described in FIG. 2, the second rectifier circuitry 106″ includes a resistor R7, a resistor R8, a resistor R9, a resistor R10, a thermistor R11, a transistor Q1, a transistor Q2, a diode D10, a breakdown diode D11, a capacitor C4_{A}, a capacitor C4_{B}, a capacitor C4_{C}, a capacitor C9, and a capacitor C10. A switch 218′ includes, for example, a metal oxide semiconductor field effect transistor (MOSFET) Q1. In some embodiments, the switch 218′ comprises a BJT. Similar to the control 302 in FIG. 3, a control 220 includes, for example, circuitry including discrete components, integrated circuits such as logic, gate arrays, etc. or a programmable solution such as a microcontroller, processor, etc. In some embodiments, the control 220 and the control 302 are the same physical control circuitry that is configured to control both rectifiers. The control 220 provides a control signal to a gate of the transistor Q1 via the resistor R7 to, for example, generate a second DC voltage such as 15V DC to drive a load 110. An example control signal to drive the transistor Q1 will be described further in regard to FIG. 5.

Similar to FIG. 3, the additional components illustrated in FIG. 4 may generally support functionality including, but not limited to, voltage and/or current storage, support for external functionality related to the power supply system 100 shown in FIG. 1 and/or a larger system into which power supply system is incorporated (e.g., a lighting fixture), overcurrent protection, etc. For example, the diode D10 is coupled between a power rail 212 and ground in parallel with the transistor Q1, the voltage drop over the diode D10 setting a minimum voltage to which the capacitor C4′ (e.g., comprising the capacitor C4_{A}, the capacitor C4_{B}, and the capacitor C4_{C}) may drop when the transistor Q1 is closed. The resistors R8 and R9 form a voltage divider to provide a reduced voltage to a clock (SCK1) 400. The resistors R10 and R12, the thermistor R11, the transistor Q2 (e.g., a BJT), the breakdown diode D11, and the capacitor C10 are configured to generate a third DC voltage (e.g., 5V). In particular, following the capacitor C4′, the resistor R12 is coupled between the power rail 212 and a gate of the transistor Q2. A cathode of the breakdown diode D11 is coupled to the gate of the transistor Q2, and an anode may be coupled to ground. A source of the transistor Q2 is coupled to the power rail 212 and a drain to the capacitor C10, the other end of which is coupled to ground. The resistor R10 is coupled to the capacitor C10, which during normal operation may generate 5V DC, and both of the thermistor R11 and the capacitor C9 are coupled in parallel to ground. The generation of the third DC voltage may be temperature sensitive based on the thermistor R11, and a reduced DC voltage generated by a voltage divider formed with the resistor R10 and the thermistor R11 may be fed to an external system such as a master in/slave out (MISO) 402 input in a microcontroller that may be, for example, controlling the operation of the power supply system 100 and/or the operation of a larger system into which power supply system 100 may be integrated (e.g., lighting fixture).

FIG. 5 illustrates an example plot 500 of a switch control signal and an example voltage at a tank capacitor in the second rectifier circuitry. More specifically, the plot 500 shows an example relationship between the voltage at the capacitor C4 (e.g., nominally 15V in this example) and the switch control signal provided to the switch 218 by the control 220 in FIG. 4. When the switch control signal is high, the switch 218 is closed, and when the switch control signal is low, the switch 218 is open. In an example of operation, the switch control signal going low may cause the switch 218 to open. The voltage of the capacitor C4 is then seen to rise steeply as the capacitor C4 charges. At some point in time based on the particular control scheme being used, the control signal may go high, causing the switch 218 to close. Closing of the switch 218 may cause the voltage of the capacitor C4 to drop gradually as the capacitor C4 discharges. This process of opening and closing the switch 218 may continue to repeat to hold the voltage of the capacitor C4 at a certain level (e.g., 15V DC). In some embodiments, the control 220 includes or emulates a hysteresis controller with analog comparators to control the level of the C4 voltage.

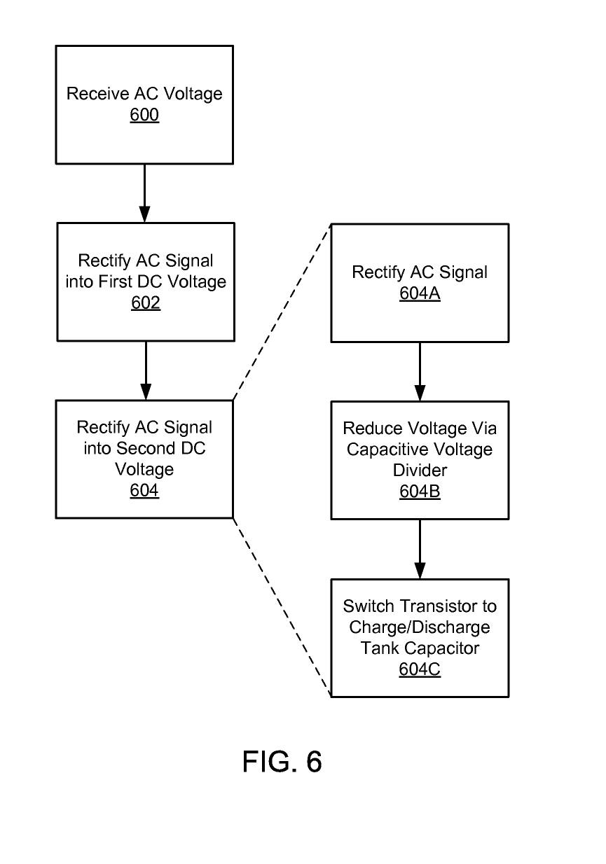

A flowchart of a method is depicted in FIG. 6. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks. Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables, are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Further, while FIG. 6 illustrates various operations, it is to be understood that not all of the operations depicted in FIG. 6 are necessary for other embodiments to function. Indeed, it is fully contemplated herein that in other embodiments of the present disclosure, the operations depicted in FIG. 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

FIG. 6 illustrates a flowchart of operations to generate a first voltage and a second voltage. In an operation 600, an AC voltage is received in a power supply system. First rectifier circuitry generates a first DC voltage based on the AC voltage in an operation 602. In an operation 604, second rectifier circuitry generates a second DC voltage based on the AC voltage. Additional detail is provided in regard to the operation 604 in FIG. 6. In an operation 604A, a diode-based full-wave rectifier in the second rectifier circuitry rectifies the AC voltage into a DC voltage. The rectified DC voltage is then reduced using capacitive voltage dividers in the second rectifier circuitry in an operation 604B. A switch in the second rectifier circuitry is controlled to charge or discharge a tank capacitor in the second rectifier circuitry to generate the second DC voltage in an operation 604C. For example, in some embodiments, a signal is provided to open or close the switch, which may cause the tank capacitor to charge or discharge, respectively, based on the reduced DC voltage and to generate the second DC voltage.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, solid state drive or device, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), tablet(s) or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

As used in any embodiment herein, a “circuit” or “circuitry” may comprise, for example, singly or in any combination, hardwired circuitry, programmable circuitry, state machine circuitry, and/or firmware that stores instructions executed by programmable circuitry.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein. The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A power supply system, comprising:
first and second input terminals to receive an alternating current (AC) voltage;
first rectifier circuitry coupled to the first and second input terminals, the first rectifier circuitry configured to generate a first direct current (DC) voltage; and
second rectifier circuitry including a first capacitor and a second capacitor coupled to the first and second input terminals, respectively, the second rectifier circuitry configured to receive the AC voltage via the first capacitor and the second capacitor and to generate a second DC voltage concurrently with the generation of the first DC voltage.

2. The power supply system of claim 1, further comprising isolation circuitry configured to receive the AC voltage from an external voltage source and to output the AC voltage to the first and second input terminals.

3. The power supply system of claim 2, wherein the isolation circuitry comprises a transformer.

4. The power supply system of claim 3, wherein the first rectifier circuitry includes the transformer and is configured as an inverter half bridge LCC converter.

5. The power supply system of claim 1, wherein the second rectifier circuitry comprises a diode full-wave rectifier, comprising:
a first diode having a cathode coupled to a power rail in the second rectifier circuitry;
a second diode having a cathode coupled to an anode of the first diode at a first node and an anode coupled to ground, wherein the first capacitor is coupled to the first node;
a third diode having a cathode coupled to the power rail; and
a fourth diode having a cathode coupled to an anode of the third diode at a second node and an anode coupled to ground, wherein the second capacitor is coupled to the second node.

6. The power supply system of claim 5, wherein the second rectifier circuitry comprises a third capacitor coupled between the power rail and ground.

7. The power supply system of claim 6, wherein the first capacitor and the third capacitor form a first capacitor voltage divider and the second capacitor and the third capacitor form a second capacitor voltage divider.

8. The power supply system of claim 6, wherein the second rectifier circuitry comprises:
a switch coupled between the power rail and ground in parallel with the third capacitor; and
control circuitry coupled to the switch.

9. The power supply system of claim 8, wherein the second rectifier circuitry comprises a fifth diode coupled between the third capacitor and the switch.

10. The power supply system of claim 8, wherein the control circuitry is configured to cause the third capacitor to charge or discharge to generate the second DC voltage at the power rail.

11. The power supply system of claim 10, wherein the control circuitry includes a hysteresis controller with analog comparators.

12. A rectifier circuit, comprising:
a first capacitor and a second capacitor to receive an alternating current (AC) voltage input to the rectifier circuit;
a diode full-wave rectifier coupled between a power rail and ground in the rectifier circuit and configured to receive the AC voltage via the first and second capacitors;
a third capacitor coupled between the power rail and ground;
a switch coupled in parallel to the third capacitor; and
control circuitry coupled to the switch and configured to cause the third capacitor to charge or discharge to generate a direct current (DC) voltage at the power rail.

13. The rectifier circuit of claim 12, wherein the first capacitor and the third capacitor form a first capacitor voltage divider and the second capacitor and the third capacitor form a second capacitor voltage divider.

14. The rectifier circuit of claim 12, wherein the control circuitry includes a hysteresis controller with analog comparators.

15. A method to rectify an alternating current (AC) voltage into a direct current (DC) voltage, comprising:
receiving an AC voltage into first rectifier circuitry;
generating a first DC voltage using the first rectifier circuitry;
receiving the AC voltage in second rectifier circuitry; and
generating a second DC voltage using the second rectifier circuitry concurrently with generating the first DC voltage.

16. The method of claim 15, wherein the AC voltage is received into the second rectifier circuitry via a first capacitor and a second capacitor in the second rectifier circuitry.

17. The method of claim 16, wherein generating the second DC voltage comprises rectifying the AC voltage with a diode full-wave rectifier in the second rectifier circuitry.

18. The method of claim 17, wherein generating the second DC voltage comprises reducing the voltage output by the diode full-wave rectifier using capacitive voltage dividers formed between both of the first and second capacitors and a third capacitor.

19. The method of claim 18, wherein generating the second DC voltage comprises controlling a switch coupled in parallel with the third capacitor to cause third capacitor to charge or discharge to generate the second DC voltage.

20. The method of claim 19, wherein controlling the switch comprises controlling the switch based on a hysteresis control scheme using analog comparators.
